(19) United States
(12) Patent Application Publication
(10) Pub. No.: US 2009/0245609 A1
(43) Pub. Date: Oct. 1, 2009

(54) ANATOMICAL ILLUSTRATION SELECTING METHOD, ANATOMICAL ILLUSTRATION SELECTING DEVICE, AND MEDICAL NETWORK SYSTEM

(75) Inventors: Hideyuki Sakaida, Tokyo (JP); Takuma Sakamoto, Tokyo (JP)

Correspondence Address: YOUNG & THOMPSON, 209 Madison Street, Suite 500, ALEXANDRIA, VA, 22314, US

(73) Assignee: FUJIFLIM CORPORATION, MINATO-KU (JP)

(21) Appl. No.: 12/442,430

(22) PCT Filed: Sep. 20, 2007
(86) PCT No.: PCT/JP2007/068248

§ 371 Date: Mar. 23, 2009

(30) Foreign Application Priority Data
Sep. 25, 2006 (JP) 2006- 258534

(51) Int. Cl. G06K 9/00; G06F 15/16

(52) U.S. Cl. 382/131; 709/203

(57) ABSTRACT

An image server has a medical image DB for storing plural medical images, an anatomical illustration DB for storing plural anatomical illustrations that are used for comparison with the medical images, and an attribute information DB. In the attribute information DB, a file name of each anatomical illustration and a site depicted in each anatomical illustration are associated with each other. Upon receipt of a transfer request of anatomical illustration from a client terminal, a CPU of the image server reads out a medical image corresponding to the file name included in the transfer request from the medical image DB. The CPU inputs the read out medical image to a site recognizing section and to recognize the site being shot. The CPU then reads out an anatomical image corresponding to the site recognized by the site recognizing section from the anatomical illustration DB and transfers it to the client terminal.

### TECHNICAL FIELD

The present invention relates to an anatomical illustration selecting method, an anatomical illustration selecting device, and a medical network system, and in particular, relates to an anatomical illustration selecting method for selecting an anatomical illustration appropriate for comparison with a designated medical image, and an anatomical illustration selecting device and a medical network system using this method.

### BACKGROUND ART

In medical facilities like clinics and hospitals, a variety of modalities, such as devices for CR (computed radiography), CT (computed tomography), MRI (magnetic resonance imaging), PET (positron emission tomography) and ultrasonic diagnosis, have been widely used. Medical images shot by the modalities are used in medical diagnoses, taking an important roll when doctors determine the symptoms of patients.

The medical images are stored in the medical facilities for several years since they are used in the prognostic diagnoses and the like. The medical facilities therefore need to store a large amount of medical images. If each medical image is stored in the form of film, a storage space becomes huge, and management and search thereof becomes a heavy burden. To avoid such situation, for example, a diagnosis support system of Japanese Patent Laid-Open Publication No. 2005-276002 digitizes medical images and stores them in a sever and the like. According to this system, the medical facilities need only to prepare the space for the server, and thus the storage space for the medical images can be significantly reduced. In addition, when the management and the search of the medical images are performed by the server, work performance in the medical facilities can be improved.

Moreover, in the above-described diagnosis support system, an anatomical illustration of the same site as the one in the medical image (head, abdomen or the like) can be displayed next to the medical image so as to accurately interpret the medical image or to explain the medical image to the patient clearly. At this time, the server automatically searches for an appropriate anatomical illustration based on site information included in order information created for the shooting session. Owing to this, the doctor need not to access the server every time for searching the appropriate anatomical illustration.

In a tomographic device of Japanese Utility Model Laid-Open Publication No. 53-076782, a position (site) to be shot in tomography is specified by a potentiometer incorporated in a platform, and an anatomical illustration corresponding to this site is provided.

According to the diagnosis support system of Japanese Patent Laid-Open Publication No. 2005-276002, however, an inappropriate anatomical illustration, not corresponding to the site shot in the medical image, may be read out when the medical image is not shot as instructed in the order information or the site information of the medical image is incorrectly recorded.

Along with the improvement of their shooting capabilities, particularly CT and MRI scanners that continuously shoot a number of tomographic images have come to capture an area (for example, whole body) larger than the site designated in the order information so that the shooting need not be performed again. In such case, the automatic search for anatomical illustrations corresponding to the shot tomographic images of sites not designated will be difficult according to the method of Japanese Patent Laid-Open Publication No. 2005-276002. In view of this, it has been desired to easily read out the anatomical illustration corresponding to the medical image even though the actually shot site is different from the site designated in the order information.

In addition, position of organs and the like differ among individuals. Therefore, even if the position to be shot is specified by the potentiometer like the method of Japanese Utility Model Laid-Open Publication No. 53-076782, the specified position does not always correspond to the site designated in the order information.

It is an object of the present invention to provide an anatomical illustration selecting method capable of selecting an anatomical illustration appropriate for a site shot in a medical image, an anatomical illustration selecting device, and a medical network system.

### DISCLOSURE OF INVENTION

In order to achieve the above object, an anatomical illustration selecting method of the present invention is characterized by selecting an anatomical illustration appropriate for comparison with a medical image designated by a user from a storage means storing plural pieces of anatomical illustrations by performing a site recognizing step and a selecting step. In the site recognizing step, an anatomical site shot in the medical image is recognized by image analysis. In the selecting step, attribute information indicating an anatomical site depicted in each of the anatomical illustrations is referred and one of the anatomical illustrations which depicts the same anatomical site as is recognized in the site recognizing step is selected.

It is preferable that examination information representing shooting details is attached to the medical image, and in the selecting step, matching of the examination information to the attribute information is further performed, and thereby selecting the anatomical illustration with a high degree of compatibility. In addition, it is preferable that the examination information includes a type of a modality which is used to shoot the medical image and a direction from which the medical image is shot. Moreover, it is preferable that the attribute information includes information corresponding to the examination information.

In addition, a read out step for reading out the anatomical illustration selected in the selecting step from the storage means and a transfer step for transferring the anatomical illustration read out in the read out step to the user are preferably provided.

Moreover, the anatomical site preferably includes brain, heart, lung, liver, stomach and other organs. In addition, the anatomical illustration is preferably a drawing and/or an image shot with a modality.

An anatomical illustration selecting device of the present invention has a site recognizing means and a selecting means, and is characterized by selecting an anatomical illustration appropriate for comparison with a medical image designated by a user from a storage means storing plural pieces of anatomical illustrations. The site recognizing means recognizes an anatomical site shot in the medical image by image analysis. The selecting means refers to attribute information indicating an anatomical site depicted in each of the anatomical illustrations and selects one of the anatomical illustrations which depicts the same anatomical site as is recognized by the site recognizing means.

It is preferable that examination information representing shooting details is attached to the medical image, and the selecting means selects the anatomical illustration with a high degree of compatibility by further performing matching of the examination information to the attribute information.

A medical network system of the present invention is constituted of a server having a storage means storing plural pieces of anatomical illustrations and a terminal, connected to the server through a network, to which the anatomical illustration appropriate for comparison with a medical image designated by a user is read out from the server, and is characterized in that the server is provided with a site recognizing means, a selecting means, a read out means, and a transfer means. The site recognizing means recognizes an anatomical site shot in the medical image by image analysis. The selecting means refers to attribute information indicating an anatomical site depicted in each of the anatomical illustrations and selects one of the anatomical illustrations which depicts the same anatomical site as is recognized by the site recognizing means. The read out means reads out the selected anatomical illustration from the storage means. The transfer means transfers the read out anatomical illustration to the terminal.

According to the present invention, an anatomical site shot in the medical image is firstly recognized, and then an anatomical illustration corresponding to the anatomical site is selected. Therefore, the anatomical illustration appropriate for the site being shot in the medical image can be selected even when the site designated in the order information is different from the site actually shot.

### BRIEF DESCRIPTION OF DRAWINGS

FIG. 1 is a block diagram schematically illustrating a structure of a medical network system;

FIG. 2 is a block diagram schematically illustrating a structure of an image server;

FIG. 3 is an explanatory view schematically illustrating a structure of an attribute information DB; and

FIG. 4 is a flow chart illustrating an operation of the medical network system.

### BEST MODE FOR CARRYING OUT THE INVENTION

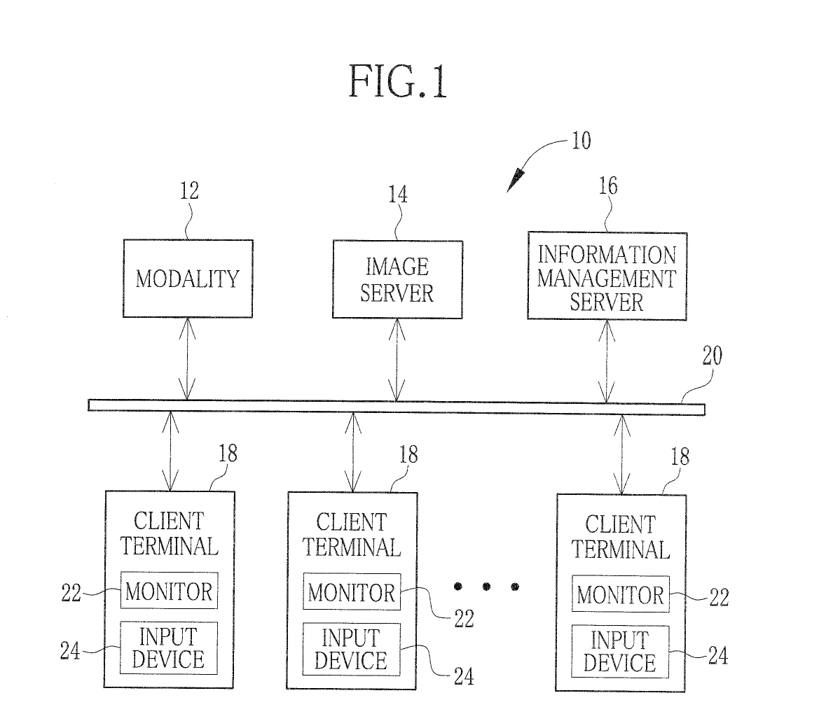

FIG. 1 is a block diagram schematically illustrating a structure of a medical network system 10 used in a medical facility like a hospital. The medical network system 10 is constituted of a modality 12 for shooting medical images, an image server (anatomical illustration selecting device) 14 for storing the medical images shot with the modality 12, an information management server 16 for managing various information inside the medical facility, and a plurality of client terminals (terminal) 18 operated by doctors during diagnoses and the like. These components are connected with each other through a LAN (network) 20 in the medical facility.

The medical network system 10 manages various information and medical images treated in the medical facility as electronic data, and thereby reducing storage space for medical records and films of medical images in the medical facility. In addition, the medical network system 10 enables to easily read out the various information and medical images using each client terminal 18, and thereby improving the efficiency of operations in the medical facility. Although FIG. 1 shows a plurality of client terminals 18, only one client terminal 18 may be provided in the system. On the contrary, more than one of each modality 12, image server 14, and information management server 16 may be provided in the system.

The image server 14 is, for example, a so-called PACS (picture archiving and communication system for medical application) server. Besides the medical images from the modality 12, the image server 14 stores medical images sent from other medical facilities via a network or media, and anatomical illustrations used for comparison with these medical images. The medical images and anatomical illustrations stored in the image server 14 are individually read out to each client terminal 18 as needed and used for an interpretation by a doctor or for explanation to a patient. The anatomical illustration includes drawings and may also include, for example, the medical images shot with the modality 12.

The information management server 16 is, for example, an HIS (hospital information system) server or a RIS (radiology information system) server. The information management server 16 manages various information including patient information, diagnosis and treatment information, examination information and account information for individual patients.

The patient information represents personal information of a patient such as, for example, patient's name, patient's ID, address, birthday, age, sex, family, anamnesis or past illnesses and allergies. The diagnosis and treatment information represents information on the diagnosis and treatment made to the patient, including the date of medical session, the department in charge, the name of disorder, the result of diagnosis, the duration of therapy, the kinds and amounts of prescribed drugs, the name of pharmacy in charge of medication, etc. The duration of therapy represents how long the patient has come to the medical facility for the therapy of the same disorder. The examination information represents information on medical images shot at each examination, including the date of examination, the machine used for the examination, the method of the examination and the site under the examination, etc. The information on the method of the examination includes directions and angles of shooting the respective medical images, such as front and side, as well as whether radiopaque is used or not. The examined sites mean body regions to be examined, such as head, neck, chest region, abdominal region, pelvic region, leg, and combination thereof like head and neck regions, thoracoabdominal region, etc. The account information includes, for example, charges for medical sessions, medications and inspections as well as whether the coverage is available or not.

In the medical facility, the client terminals 18 are put in, for example, every examination room or every department. Each client terminal 18 is constituted of, for example, a well-known personal computer or work station, and includes a monitor 22 for displaying various information and medical images, an input device 24 for inputting various information, and the like. During the session with the patient, the doctor explains the result of diagnosis while displaying the medical image shot with the modality 12 or the information read out from the information management server 16 on the monitor 22. In addition, the doctor inputs information obtained through the session using the input device 24. Note that well-known input devices like a keyboard and a mouse are used as the input device 24.

Moreover, in the information management server 16, a reservation list of the modality 12 is formed. When shooting with the modality 12 is needed, the doctor accesses the reservation list in the information management server 16 through the client terminal 18. When available date in the reservation list is selected and order information instructing content of examination (examination details) is input, the examination using the modality 12 is reserved. The information management server 16 sends the order information to the client terminal 18 and the modality 12 in a radiologic department periodically or every time a new examination reservation is received. A doctor or an operator of the radiologic department operates the modality 12 and takes medical images according to the order information.

In this way, the information management server 16 manages information for respective patients, and also manages available status of the modality 12 so that the examinations will not be overbooked in the same period of time. The order information includes, for example, the method of the examination, the site under the examination, the patient's ID, the ID of the doctor who has requested the examination, etc.

As the modality 12, well-known medical imaging devices, such as devices for ultrasonic diagnosis, CR, CT and MRI, are used. Medical images shot with the modality 12 are sent to the image server 14 through the LAN 20. At this time, the modality 12 writes a patient's ID and the like as metadata to the medical images based on the order information. Owing to this, the medical images can be easily identified as to which patient the images belong to. Besides the digital medical images shot with the modality 12 having imaging elements, the medical images include those shot with analogue modality 12 and then digitized by a scanner (not shown).

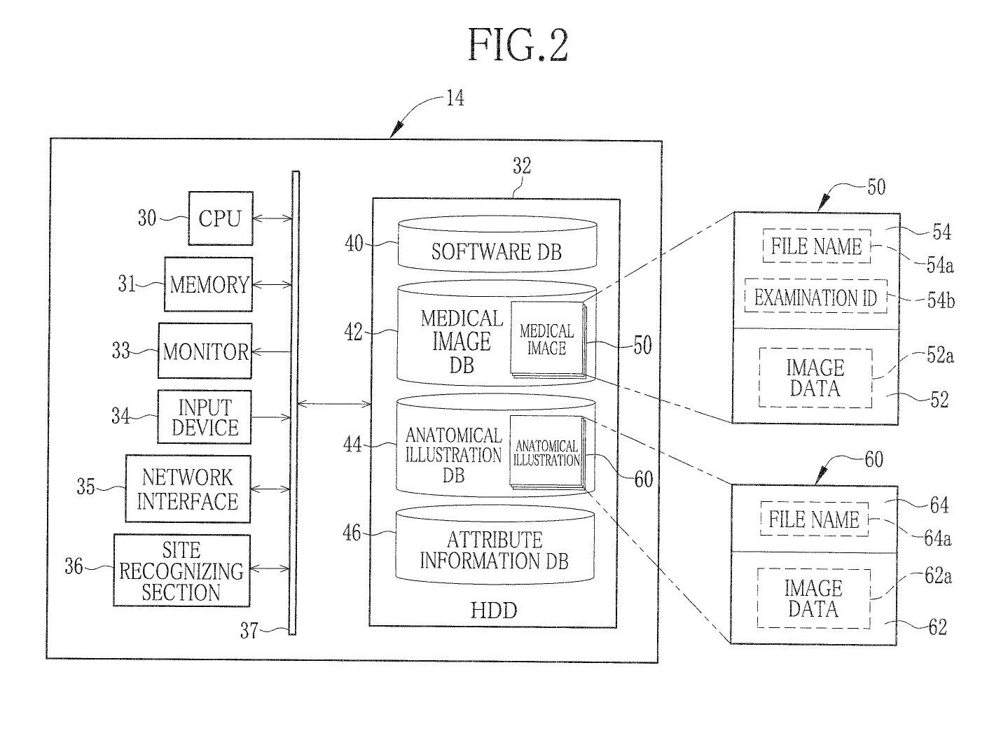

FIG. 2 is a block diagram schematically illustrating a structure of the image server 14. The image server 14 is constituted of a well-known personal computer or work station, and includes a CPU (selecting means) 30, a memory 31, a HDD (storage means) 32, a monitor 33, an input device 34, a network interface (transfer means) 35 and a site recognizing section (site recognizing means) 36. These components are connected with each other through a bus 37.

In the HDD 32, various databases, such as a software database (DB) 40 for storing various programs for the medical network system 10, a medical image DB 42 for storing medical images 50, an anatomical illustration DB 44 for storing anatomical illustrations 60 that are used for comparison with the medical images 50, and an attribute information DB 46 for collectively recording attributes of the respective anatomical illustrations 60 are formed.

The CPU 30 reads out each program from the software DB 40 and deploys it to the memory 31. The CPU 30 entirely controls the image server 14 by sequentially operating the read out program. In addition, the CPU 30 stores the medical images 50, input through the network interface 35, in the medical image DB 42 of the HDD 32. The CPU 30 then reads out the medical image 50 from the medical image DB 42 according to the request from each client terminal 18 and transfers it to the client terminal 18 which requested.

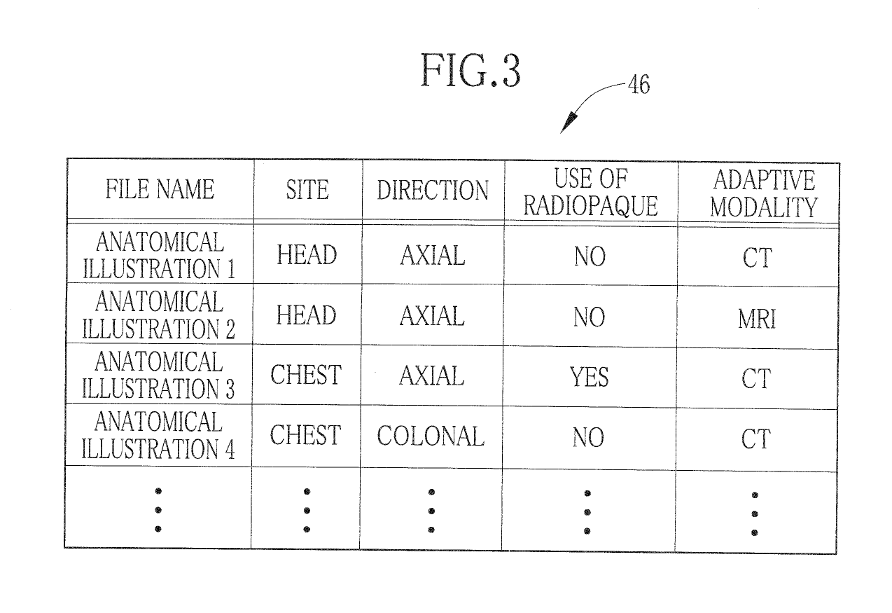

As shown in FIG. 3, attributes of each anatomical illustration 60 such as, for example, information on a site depicted in each anatomical illustration 60, a direction from which the anatomical illustration 60 is depicted, whether the radiopaque is used or not, an adaptive modality, etc are recorded in the attribute information DB 46 in association with file name of each anatomical illustration 60. The attribute information DB 46 is used when the CPU 30 searches for the anatomical illustration 60. The adaptive modality is the most appropriate modality 12 for obtaining each of the anatomical illustration 60. For example, an adaptive modality for an anatomical illustration in which the cranium and ribs are removed is designated as the MRI scanner which will not provide clear pictures of bones. An adaptive modality for an anatomical illustration in which the cranium and ribs are clearly depicted, on the other hand, is designated as the CT scanner which shows clear pictures of bones. In this way, the adaptive modality is designated in consideration of the characteristics of each modality 12. In addition to the above-described items, the attributes of the anatomical illustration 60 may include, for example, the content of the examination.

Although the various programs and the medical images 50 are stored together in the HDD 32 in this embodiment, they can be stored in separate HDDs. In addition, the medical images 50 and the like are stored in the built-in HDD 32 in this embodiment. However, the medical images 50 and the like may be stored in an external HDD or other kinds of media like DVD-ROM or CD-ROM.

The monitor 33 displays various operation screens corresponding to processing of the program by the CPU 30. Note that a well-known display device, such as crystal liquid display or CRT display, is used as the monitor 33. The input device 34 may be constituted of a keyboard and a mouse. The monitor 33 and the input device 34 are used when an administrator in the medical facility renews the programs stored in the software DB 40 or for checking the storage status of the medical images 50 in the medical image DB 42 and the anatomical illustrations 60 in the anatomical illustration DB 44. The network interface 35 connects the image server 14 to the LAN 20 of the medical network system 10. The network interface 35 is Ethernet (trademark) or the like selected according to the standard of the LAN 20.

The site recognizing section 36 performs image analysis of the input medical image 50 and recognizes which site is shot. The image analysis by the site recognizing section 36 is performed by, for example, calculating feature quantity of the image based on the density of each pixel and matching it to feature quantity of each site preliminarily stored.

As shown in FIG. 2, each medical image 50 has an image recording area 52 for recording image data 52a and a tag area 54 for recording metadata, such as a file name 54a, an examination ID 54b, and the like. The file name 54a is given to each medical image 50. The examination ID 54b is a specific number given to each examination. This examination ID 54b makes it possible to identify which examination the medical image 50 is shot for and used to manage a plurality of medical images 50 shot at an identical examination altogether.

Similar to the medical image 50, each anatomical illustration 60 has an image recording area 62 for recording image data 62a and a tag area 64 for recording metadata, such as a file name 64a given to each anatomical illustration 60, and the like.

The metadata to be recorded in the tag areas 54 and 64 can respectively be recorded synchronously with the image data 52a and 62a at the time of producing the medical image 50 and the anatomical illustration 60. The metadata can also be recorded in the image server 14 or in the client terminal 18 after the production of the anatomical illustration 60. Note that the metadata is not limited to the above embodiment, but any other information is recorded in the tag areas 54 and 64. As an example of file format for such medical image 50 as having the tag area 54 and anatomical illustration 60 as having the tag area 64, DICOM (digital imaging and communications in medicine) format is usable.

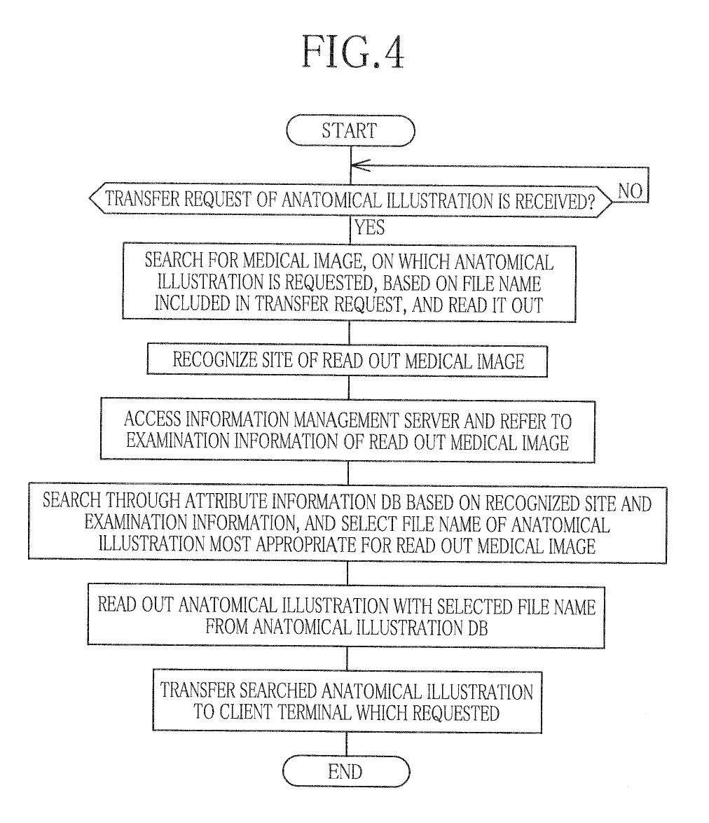

Now the operation of the medical network system 10 will be described with reference to the flowchart shown in FIG. 4. The doctor who finds it necessary to shoot images with the modality 12 accesses the reservation list of the information management server 16 through the client terminal 18, and makes reservation for examination using the modality 12 by inputting order information on the date available in the list. The input order information is delivered from the information management server 16 to the client terminal 18 and the modality 12 in the radiologic department.

The operator (radiologist or radiologic technician) of the modality 12 who has checked the order information performs the shooting based on the order information, and obtains medical images 50 of the site under the examination which was designated in the order information.

The obtained medical images 50 are transferred to the image server 14 through the LAN 20. The CPU 30 of the image server 14 stores the received medical images 50 in the medical image DB 42 of the HDD 32. At this time, the modality 12 stores information of the shooting direction, information of the shot site etc. as the examination information to be attached to the shot medical images 50 in the information management server 16.

The doctor who finds the medical image 50 necessary for image interpretation or explanation to the patient sends a transfer request of the medical image 50 to the image server 14 through the client terminal 18. This transfer request includes the examination ID for identifying the medical image 50. Note that the examination ID may be directly input by the doctor, or selected from a list of medical images 50 formed for individual patient based on the examination information stored in the information management server 16.

The CPU 30 of the image server 14 searches through the medical image DB 42 of the HDD 32 upon receipt of the transfer request of the medical image 50, and reads out a medical image 50 whose examination ID 54b recorded as metadata in its tag area 54 corresponds to the examination ID included in the transfer request. In this way, an appropriate medical image 50 can effectively be read out even in the case where more than one examination is performed to one patient.

After reading out the medical image 50, the CPU 30 checks an address of the client terminal 18 which requested, and transfers a copy of the read out medical image 50 to this client terminal 18. After obtaining the medical image 50 from the image server 14, the doctor displays the medical image 50 on the monitor 22 of the client terminal 18 and interprets the image or explains the medical condition to the patient.

When the doctor finds the anatomical illustration 60 necessary for comparison with the medical image 50 while observing it, the doctor sends a transfer request of the anatomical illustration 60 to the image server 14 through the client terminal 18. The transfer request of the medical image 60 includes the file name of the medical image 50 to be compared. Note that the file name of the medical image 50 may be directly input by the doctor, or the file name of the medical image 50 displayed on the monitor 22 may automatically be input.

The CPU 30 of the image server 14 searches through the medical image DB 42 of the HDD 32 upon receipt of the transfer request of the anatomical illustration 60, and reads out a medical image 50 having the file name 54a included in the transfer request. The CPU 30 inputs the read out medical image 50 to the site recognizing section 36 to make it recognize the site shot in this medical image 50.

In addition, the CPU 30 accesses the information management server 16 and refers to the examination information of the medical image 50, and thereby obtaining the information on the direction from which the medical image 50 is shot, whether the radiopaque is used or not, and the modality used for shooting. After obtaining the examination information of the medical image 50, the CPU 30 accesses the attribute information DB 46.

By accessing the attribute information DB 46, the CPU 30 searches for an anatomical illustration 60 of the same site as is recognized by the site recognizing section 36. Moreover, the CPU 30 judges a degree of compatibility between each attribute excluding the site of the anatomical illustration 60 and the examination information of the medical image 50. The CPU 30 judges the anatomical illustration 60 which corresponds to the recognized site and has the highest degree of compatibility in each attribute excluding the site as the most appropriate anatomical illustration 60, and selects the file name thereof.

In the case where, for example, the site recognized by the site recognizing section 36 is “chest”, and the shooting direction of the medical image 50, the use of the radiopaque, and the shooting modality that are recorded in the examination information are respectively “axial”, “YES” and “CT”, the CPU 30 selects “anatomical illustration 3” (see FIG. 3) whose attributes correspond to respective items as the most appropriate anatomical illustration 60. There may be a case that two or more anatomical illustrations 60 have the same degree of compatibility. For such occasions, it is possible to preliminarily give prioritized order to each anatomical illustration 60 so that only one anatomical illustration 60 is selected.

After selecting the file name from the attribute information DB 46, the CPU 30 accesses the anatomical illustration DB 44, and reads out an anatomical illustration 60 having the selected file name. After reading out the anatomical illustration 60, the CPU 30 checks an address of the client terminal 18 which requested, and transfers a copy of the read out anatomical illustration 60 to this client terminal 18. After receiving the anatomical illustration 60, the client terminal 18 displays this anatomical illustration 60 next to the medical image 50. In this way, the site shot in the medical image 50 is recognized first and the anatomical illustration 60 corresponding to this site is selected according to the present invention. Therefore, even when the site designated in the order information is different from the site actually shot, the anatomical illustration 60 appropriate for the medical image 50 to be compared can be selected.

In the above embodiment, the medical image 50 is firstly transferred to the client terminal 18, and then the anatomical illustration 601 is transferred according to the transfer request from the user. However, the timing of transferring the anatomical illustration 60 is not limited to this. For example, an appropriate anatomical illustration 60 may be read out at the time when the medical image 50 is requested to be transferred, and the anatomical illustration 60 may be transferred to the client terminal 18 together with the medical image 50.

In the above embodiment, the site of the medical image 50 is recognized at the time of receiving the transfer request of the anatomical illustration 60 from the user. The timing of the site recognition is not limited to this, but may be performed when, for example, storing the medical image 50 which has sent from the modality 12 in the medical image DB 42. In this case, the recognized site may be recorded in the tag area 54 so as to be read out when selecting the anatomical illustration 60.

Although the attributes of the anatomical illustration 60 are collectively recorded in the attribute information DB 46 in the above embodiment, the present invention is not limited to this. For example, each attribute may be recorded as metadata in the tag area 64 of the anatomical illustration 60. In addition, although the examination information of the medical image 50 is recorded in the information management server 16, the present invention is not limited to this. For example, the examination information may be recorded as metadata in the tag area 54 of the medical image 50.

In the above embodiment, head, neck, chest region, abdominal region, pelvic region, leg, and the like are shown as the anatomical sites. However, the anatomical sites may also include, for example, organs like brain, heart, lung, liver, stomach and the like.

In the above embodiment, the present invention is applied to the medical network system 10 used in one medical facility. However, the present invention may also be applied to, for example, a medical network system in which more than one medical facility is interconnected. Moreover, although the image server 14 is shown as the anatomical illustration selecting device, the present invention is also applicable in a case where, for example, the client terminal 18 is used as the anatomical illustration selecting device.

### INDUSTRIAL APPLICABILITY

The present invention is utilized for a diagnosis using a medical image so as to select an anatomical illustration most appropriate for comparison with the medical image.

1. An anatomical illustration selecting method for selecting an anatomical illustration appropriate for comparison with a medical image designated by a user from a storage means storing plural pieces of anatomical illustrations, said anatomical illustration selecting method comprising:
a site recognizing step for recognizing an anatomical site shot in said medical image by image analysis; and
a selecting step for referring to attribute information indicating an anatomical site depicted in each of said anatomical illustrations and selecting one of said anatomical illustrations which depicts the same anatomical site as is recognized in said site recognizing step.

2. The anatomical illustration selecting method of claim 1, wherein said medical image has examination information representing shooting details attached thereto, and wherein
in said selecting step, said anatomical illustration with a high degree of compatibility is selected by further matching said examination information to said attribute information.

3. The anatomical illustration selecting method of claim 2, wherein said examination information includes a type of a modality used to shoot said medical image and a direction from which said medical image is shot.

4. The anatomical illustration selecting method of claim 2, wherein said attribute information includes information corresponding to said examination information.

5. The anatomical illustration selecting method of claim 1, further including:
a read out step for reading out said anatomical illustration selected in said selecting step from said storage means; and
a transfer step for transferring said anatomical illustration read out in said read out step to said user.

6. The anatomical illustration selecting method of claim 1, wherein said anatomical site includes brain, heart, lung, liver, stomach and other organs.

7. The anatomical illustration selecting method of claim 1, wherein said anatomical illustration is a drawing and/or an image shot with a modality.

8. An anatomical illustration selecting device for selecting an anatomical illustration appropriate for comparison with a medical image designated by a user from a storage means storing plural pieces of anatomical illustrations, said anatomical illustration selecting device comprising:
a site recognizing means for recognizing an anatomical site shot in said medical image by image analysis; and
a selecting means for referring to attribute information indicating an anatomical site depicted in each of said anatomical illustrations and selecting one of said anatomical illustrations which depicts the same anatomical site as is recognized by said site recognizing means.

9. The anatomical illustration selecting device of claim 8, wherein said medical image has examination information representing shooting details attached thereto, and wherein
said selecting means selecting said anatomical illustration with a high degree of compatibility by further matching said examination information to said attribute information.

10. A medical network system constituted of a server having a storage means storing plural pieces of anatomical illustrations and a terminal, connected to said server through a network, to which said anatomical illustration appropriate for comparison with a medical image designated by a user is read out from said server said server comprising:
a site recognizing means for recognizing an anatomical site shot in said medical image by image analysis;
a selecting means for referring to attribute information indicating an anatomical site depicted in each of said anatomical illustrations and selecting one of said anatomical illustrations which depicts the same anatomical site as is recognized by said site recognizing means;
a read out means for reading out said selected anatomical illustration from said storage means; and
a transfer means for transferring said read out anatomical illustration to said terminal.
